(19) United States
(12) Patent Application Publication
(10) Pub. No.: US 2026/0088425 A1
(43) Pub. Date: Mar. 26, 2026

(54) Battery Assembly for a Pedal Driven Vehicle and Pedal Driven Vehicle with Battery Assembly

(71) Applicant: Robert Bosch GmbH, Stuttgart (DE)

(72) Inventors: Dennis Ehard, Eningen Unter Achalm (DE); Fabio de Felice, Denkendorf (DE); Ralf Stopper, Rottenburg-Wendelsheim (DE); Simon Gerold, Stuttgart (DE); Tobias Thiel, Reutlingen (DE)

(21) Appl. No.: 19/334,888

(22) Filed: Sep. 21, 2025

(30) Foreign Application Priority Data
Sep. 24, 2024 (DE) 10 2024 209 185.5

(51) Int. Cl. H01M 50/249; H01M 50/213; H01M 50/242; H01M 50/264; H01M 50/291

(52) U.S. Cl. CPC H01M 50/249; H01M 50/213; H01M 50/242; H01M 50/264; H01M 50/291; H01M 2220/20

(57) ABSTRACT

A battery assembly for a pedal driven vehicle includes at least one battery module. The battery module includes a plurality of battery cell packs. The battery cell packs are arranged in a row along a longitudinal axis. At least one battery cell pack includes at least one cell holder and a plurality of battery cells. The battery cells are arranged on the cell holder in such a way that a cavity is formed between the battery cells. The cavity is delimited, at least in sections, by the cell holder and/or the battery cells with respect to its circumference.

This application claims priority under 35 U.S.C. § 119 to application no. DE 10 2024 209 185.5, filed on Sep. 24, 2024 in Germany, the disclosure of which is incorporated herein by reference in its entirety.

### BACKGROUND

A plurality of battery cells are typically used in battery assemblies for pedal powered vehicles. In order to realize the most advantageous integration of the battery assembly into a vehicle, in particular a bicycle, it is desirable to realize as compact a manner of the assembly of the battery cells as possible. With regard to the arrangement of the battery cells, there is the aim to achieve sufficiently compact overall dimensions while also providing sufficient installation space for other functional components of the battery assembly and ensuring safe operation of the battery assembly.

### SUMMARY

The present disclosure relates to a battery assembly for a pedal driven vehicle, as well as a pedal driven vehicle having such a battery assembly. Further features and details of the disclosure will emerge from the description and the drawings. In this context, features and details described in connection with the battery assembly according to the disclosure clearly also apply in connection with the pedal driven vehicle according to the disclosure, and vice versa, so that mutual reference to the individual considerations of the disclosure always is or can be made with respect to the disclosure.

In particular, the present disclosure serves to enable a safe and advantageous arrangement of battery cells within a battery assembly.

According to a first aspect, the present disclosure relates to a battery assembly for a pedal powered vehicle, in particular an electric bicycle. The battery assembly includes at least one battery module, the battery module comprising a plurality of battery cell packs, wherein the battery cell packs are arranged in a row along a longitudinal axis.

At least one battery cell pack comprises at least one cell holder, as well as a plurality of battery cells. In particular, it can be provided that at least one battery cell pack comprises at least two or precisely two, at least four or precisely four, at least six or precisely six, or at least eight or precisely eight battery cells. With respect to the present disclosure, the use of four battery cells has proven particularly advantageous.

According to the present disclosure, the battery cells are arranged on the cell holder such that a cavity is formed between the battery cells, wherein the cavity is delimited with respect to its circumference, at least in sections, by the cell holder and/or the battery cells. With respect to the present disclosure, it may be contemplated that the cavity may be completely delimited with respect to its circumference by the cell holder and/or the battery cells.

In other words, a battery assembly for a pedal powered vehicle, in particular an electric bicycle or pedelec, is proposed. The battery assembly includes at least one battery module, wherein the battery module in turn comprises a plurality of battery cell packs. The battery cell packs are arranged in a row along a longitudinal axis or adjacent to each other.

At least one battery cell pack comprises a cell holder, as well as at least two or more than two battery cells. According to the disclosure, it is provided that the battery cells are arranged on the cell holder such that a cavity is formed between the battery cells. This cavity is delimited with respect to its circumference, at least in sections, by the cell holder and/or the battery cells. The limitation can in particular be carried out, at least in sections, by a side wall of the battery cells.

The advantage of a battery assembly according to the disclosure is that the cavity provided between the battery cells can be used to arrange further functional elements of the battery assembly. In particular, the cavity can be used to arrange sensors for operational monitoring and/or cable guidance. Laying these functional elements in the cavity, at least in part, offers the option of implementing an overall compact design of the battery assembly. At the same time, the respective functional elements in the cavity are protected from external influences, whereby a safe and reliable operation of the battery assembly can be supported.

It may be provided that the features and functions described in relation to a battery cell pack and/or a battery cell and/or a separating element and/or a cell holder may be realized equally, or at least in part, in further battery cell packs and/or battery cells and/or separating elements and/or cell holders. In particular, at least two battery cell packs and/or battery cells and/or separating elements and/or cell holders may have an identical or substantially identical construction.

With respect to the present disclosure, it can be advantageously provided that the battery cells are arranged on the cell holder such that area centers of the battery cells form a trapezoid in cross-section, in particular an isosceles trapezoid, in cross-section. In particular, the are centers may form the corners of the trapezoid and/or lie on sides of the trapezoid. The cross-sectional plane underlying the cross-section is preferably a cross-sectional plane oriented orthogonally to the longitudinal axis or a cross-sectional plane defined by a transverse axis and a vertical axis, wherein the transverse axis and the vertical axis are oriented orthogonally to each other and orthogonally to the longitudinal axis. In other words, it may preferably be provided that at least one battery cell pack comprises at least four battery cells. In particular, it is contemplated that two of the four battery cells form a first pair and the further two battery cells form a second pair, wherein the battery cells of each pair are in the same position and height with respect to the vertical axis. Further, it may preferably be provided that the battery cells of the first pair have a smaller distance with respect to a transverse axis or along a transverse axis than the battery cells of the second pair. The vertical axis and the transverse axis are each orthogonal to the longitudinal axis and orthogonal to each other. Such an arrangement of the battery cells in at least one battery cell pack has proven to be advantageous with regard to a compact overall structure of the battery assembly or a battery cell pack as well as generous dimensioning of the cavity.

Advantageously, with regard to the present disclosure, it can be provided that at least one battery cell is cylindrical and in particular the cavity has a maximum width of at least 50%, in particular at least 55% or at least 60% of the diameter of the battery cell. In the present case, the maximum width means a maximum extension of the cavity along a transverse axis, wherein the transverse axis is oriented orthogonally to the longitudinal axis and/or orthogonally to a vertical axis. In particular, the maximum width of the cavity may be at least 8 mm, preferably at least 10 mm, more preferably at least 12 mm, or at least 14 mm.

Additionally or alternatively, the cavity may have a maximum depth of at least 80%, in particular at least 85% or at least 90% of the diameter of the battery cell. In the present case, the maximum depth means a maximum extension of the cavity along the longitudinal axis. In particular, the depth of the cavity may be at least 15 mm, in particular at least 18 mm, in particular preferably between 18 mm and 20 mm.

Additionally or alternatively, the cavity may be provided to have a maximum height that is less than the diameter of the battery cell. In the present case, the maximum height means a maximum extension of the cavity along a vertical axis, wherein the vertical axis is oriented orthogonally to the longitudinal axis and/or orthogonally to a transverse axis. In particular, the height of the cavity may be a maximum of 21 mm, in particular a maximum of 18 mm, preferably between 5 mm and 20 mm, or between 8 mm and 18 mm.

Dimensioning of the cavity according to one or more of the above requirements has proven to be advantageous with respect to a sufficient construction space formed by the cavity.

Advantageously, it can further be provided that a center of gravity of at least one battery cell pack lies within the cross-section within the cavity. The cross-sectional plane underlying the cross-section is preferably a cross-sectional plane oriented orthogonally to the longitudinal axis or a cross-sectional plane defined by a transverse axis and a vertical axis, wherein the transverse axis and the vertical axis are oriented orthogonally to each other and orthogonally to the longitudinal axis. In other words, it can be provided that, in at least one battery cell pack, at least the cell holder (or a plurality of cell holders) and the battery cells are positioned and designed relative to one another in such a way that a center of gravity, in particular a center of mass, of the battery cell pack lies within the cavity with respect to a positioning of the center of gravity along a vertical axis and a transverse axis. Additionally or alternatively, it may be provided that the cavity is centrally or substantially centrally positioned relative to an extension of the battery cell pack along the longitudinal axis.

For the present disclosure, it may be advantageous if a separating element is arranged on at least one end face of at least one battery cell pack, in particular along the longitudinal axis, wherein preferably the separating element delimits the cavity with respect to an extension along the longitudinal axis, in particular on one side. The separating element may preferably form an end cap of the battery cell pack. Additionally or alternatively, an extension of the cavity along the longitudinal axis, in particular on a side of the cavity opposite the separating element, can be delimited by the cell holder. In this context, it is in particular contemplated that the cavity, entirely or substantially entirely, will be delimited by the cell holder, the battery cells and the separating element.

Referring to the present disclosure, it may further be provided that the separating element comprises at least one protective rib for, at least partially, shielding the cavity from a hot gas escaping from an end face of a battery cell. In particular, it is contemplated that the protective rib delimits the cavity from the battery cell, at least in sections, and/or forms a collar on the battery cell that projects from the front side of the battery cell. Battery cells can experience a thermal runaway, which can cause hot gases to escape from the battery cell, in particular at the front. Contact of these hot gases with other battery cells may damage them and cause further malfunctions. The protective rib reduces the flow of the hot gas into the cavity and thus to other battery cells improving the safety of the battery assembly.

At least one protective rib can be arranged, at least in sections, in contact with at least one or exactly one battery cell or immediately adjacent to the battery cell or the battery cells. Additionally or alternatively, at least one protective rib may be formed, at least in sections, complementary to the circumference of at least one battery cell. As a result, the protective rib can be applied to the battery cell following its contour, resulting in an improved protection function of the protective rib.

It may be provided that at least one separating element comprises a plurality of protective ribs. In particular, the number of protective ribs may correspond to the number of battery cells on the relevant battery cell pack, wherein each guard rib is associated with a battery cell. At least two protective ribs may be identical or substantially identical.

Additionally or alternatively, it may be advantageously provided that the separating element comprises at least one centering rib for centering the separating element on the cell holder, wherein preferably the centering rib is arranged, at least in sections, in contact with the cell holder. The use of a centering rib provides the advantage of simplified assembly of the separating element on the cell holder. In addition, errors during assembly in the form of incorrect positioning of the separating element relative to the cell holder can be easily and effectively avoided.

Preferably, at least one protective rib and at least one centering rib, in particular all protective ribs and all centering ribs, can be configured as a continuous rib contour or a continuous rib. In other words, it can be provided that at least one protective rib and a centering rib are not configured as separate ribs, but rather are commonly formed by a rib element or a rib. This results in a simplified construction of the separating element as well as further advantages with respect to a simpler and more cost-efficient manufacture.

With respect to at least one rib contour, it can be provided that at least one centering rib, in particular all centering ribs, are arranged between two protective ribs. Additionally or alternatively, it is conceivable that at least one protective rib and/or centering rib, at least in sections, in particular in positive locking, will engage the cavity.

With respect to the present disclosure, it may further be advantageous if at least one cell holder comprises a centering mechanism on an adjacent cell holder, wherein the centering mechanism comprises at least one centering recess for, in particular, positive locking, inclusion of a centering process and/or at least one centering process for insertion into a centering recess.

For the centering of two cell holders to each other, it can in particular be provided that a first cell holder comprises a centering mechanism and a second cell holder comprises complementary centering mechanism for this purpose. Thus, for example, the first cell holder may exclusively comprise centering recesses for receiving centering extensions of the second cell holder and the second cell holder exclusively comprise centering extensions for insertion into the centering recesses of the first cell holder. Alternatively, it may be provided that at least one cell holder comprises at least one centering recess as well as at least one centering extensions. In particular, a combined arrangement of at least one centering recess and at least one centering extensions with at least one cell holder has proven to be advantageous with respect to the present disclosure.

Through the use of centering mechanism, accurate and reliable positioning of the cell holders relative to each other can be realized. In particular, it can be provided that at least one further cell holder comprises complementary or identical centering mechanism. Thus, the respective centering extensions of the cell holders can be introduced into the recess of the respective other cell holder for centering.

Preferably, it can be provided that at least one battery cell pack comprises at least two cell holders, wherein the cell holders are centered relative to each other via the centering mechanism and/or connected to each other. Additionally or alternatively, at least two cell holders adjacent to each other may be centered or connected to each other via the centering mechanism relative to each other.

Advantageously, it can be provided that at least one centering extension, in particular in a first cell holder, and at least one centering recess, in particular in a second cell holder, are configured such that a fit between the centering extension, in particular the first cell holder, and the centering recess, in particular the second cell holder, is configured as an interference fit. In other words, it may be contemplated that the centering extension is greater than the centering recess with respect to each tolerance position. This enables a play-free and self-locking, and therefore particularly secure, connection between two cell holders via the centering mechanism.

With respect to the present disclosure, it has proven particularly advantageous when at least one centering process is formed by at least two spring segments. For example, at least one centering extension may be configured as a hollow cylinder, wherein a jacket of the hollow cylinder is divided by at least two recesses into at least two segments, in particular spring segments. The recesses reduce the rigidity of the jacket in the remaining segments and enable it to perform a spring function. A simplified connection of cell holders via the centering mechanism can thereby be realized. At least one centering extension may be formed by more than two spring segments. In particular, the formation of at least one centering extension by at least three or precisely three spring segments has proven to be advantageous in the present case.

Additionally or alternatively, it is conceivable that at least one centering extension is formed as an integral part, in particular made of the same material and/or in one piece, with the cell holder and/or that at least one centering chamfer is formed on the centering extension, in particular at an end facing away from the cell holder. Such a centering chamfer can in particular be configured on each spring segment. This facilitates insertion of the centering extension into a centering recess.

Furthermore, it may be provided that at an end of at least one centering extension or at least one spring segment facing the cell holder, the material thickness of the cell holder is reduced, at least in sections. For example, a groove may be formed for this purpose, which follows the outer circumference of the centering extension or spring segment, in particular immediately adjacent to the centering projection or spring segment. As a result, the stiffness of the centering extension or the spring element in question can be further reduced and the spring function improved.

Further, with respect to the present disclosure, it is conceivable that the cell holder comprises at least one, in particular primary, spring element for securing a battery cell to the cell holder, wherein the, in particular primary, spring element can be preloaded against the battery cell by an arrangement of the battery cell on the cell holder. A reliable and position-fixed securing of the battery cell to the cell holder can thereby be realized.

Preferably, with respect to the present disclosure, it can be further provided that at least one, in particular primary, spring element forms a delimitation of the cavity. In particular, the spring element may be provided to limit the cavity with respect to its circumference, at least in sections. This results in a particularly compact design of the battery assembly, as the spring element is arranged in a particularly space-saving manner in the interior of the battery assembly. Further, this arrangement results in a higher design freedom with respect to at least one, in particular primary, spring element. Thus, larger dimensions of the spring element and thus higher preload forces may be realized in the area of the cavity.

With respect to the disclosure, it is further conceivable that a housing for receiving the at least one battery cell pack is comprised by the battery assembly, wherein the cell holder comprises at least one, in particular secondary, spring element for securing the cell holder in the housing, wherein the, in particular secondary, spring element can be preloaded against the housing by an arrangement of the battery cell pack.

At least one, in particular primary or secondary, spring element may be configured as a leaf spring. Additionally or alternatively, at least one, in particular primary or secondary, spring element may be formed as an integral component of a cell holder or monolithic and/or materially unitary with the cell holder. In addition or alternatively, at least one, in particular cylindrical, receiving section may be provided on at least one cell holder for at least partially receiving at least one battery cell in a form-fitting manner. In this context in particular, it can be provided that at least one, in particular primary or secondary, spring element forms a wall of the receiving portion, at least in sections.

It may be provided in the context of the disclosure that at least one spring element, in particular primary or secondary, has an extension of at least 8 mm with respect to the longitudinal axis, in particular at least 9.5 mm, preferably at least 10 mm, in particular preferably between 10 mm and 11 mm. Additionally or alternatively, at least one, in particular primary or secondary, spring element may have a material thickness of at least 1 mm, in particular at least 1.5 mm, or at least 1.8 mm, in particular between 1.5 mm and 2.5 mm. Additionally or alternatively, at least one, in particular primary or secondary, spring element may have a width of at least 3 mm, in particular at least 4 mm, preferably at least 5 mm.

It can advantageously be provided that at least one spring element, in particular primary, is configured such that by an arrangement of a battery cell on the cell holder, the spring element, in particular primary, can be preloaded by a spring travel of at least 0.2 mm, in particular at least 0.3 mm or at least 0.4 mm. Additionally or alternatively, it is conceivable that at least one, in particular secondary, spring element is configured such that by an arrangement of the cell holder in the housing the, in particular secondary, spring element can be preloaded by a spring travel of at least 0.2 mm, in particular at least 0.3 mm or at least 0.4 mm. The spring travel preferably relates to an exposed end of the spring element.

According to a second aspect, the present disclosure further relates to a pedal powered vehicle, wherein the pedal powered vehicle comprises at least one battery assembly according to the disclosure, in particular at least one battery assembly according to description set forth below. With respect to a pedal powered vehicle, the same advantages result as described in relation to a battery assembly according to the disclosure. Preferably, the pedal powered vehicle may be used as an electric cycle, in particular pedelec.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination.

The figures schematically show the following:

FIG. 1 shows a view of a battery assembly,

FIG. 2 shows a view of a battery assembly,

FIG. 3 shows a view of a battery cell pack,

FIG. 4 shows a view of a battery cell pack,

FIG. 5 shows a view of a battery assembly,

FIG. 6 shows a view of a battery assembly,

FIG. 7 shows a view of a cell holder,

FIG. 8 shows a view of a cell holder, and

FIG. 9 shows a pedal-powered vehicle.

### DETAILED DESCRIPTION

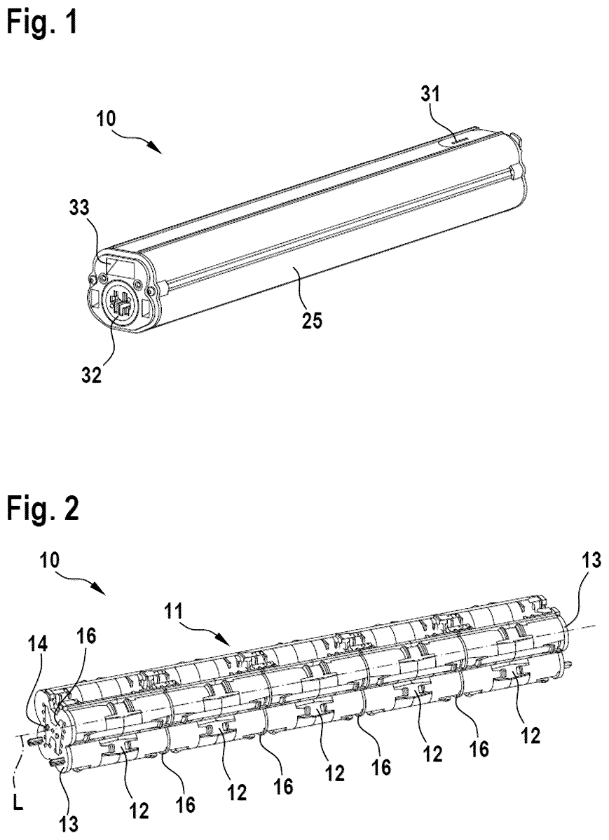

FIG. 1 shows a schematic view of a battery assembly 10 for a pedal powered vehicle 50. The battery assembly includes a housing 25, a charge status indicator 31, an electrical interface 32 for introducing electrical energy into the battery assembly, and/or for applying electrical energy out of the battery assembly, and a mechanical mounting interface 33 for mounting the battery assembly to a pedal driven vehicle 50.

FIG. 2 shows a schematic view of a portion of the interior of the battery assembly 10 shown in FIG. 1. It will be apparent from FIG. 2 that the battery assembly 10 comprises a battery module 11, wherein the battery module 11 in turn comprises a plurality of battery cell packs 12 arranged together along a longitudinal axis L.

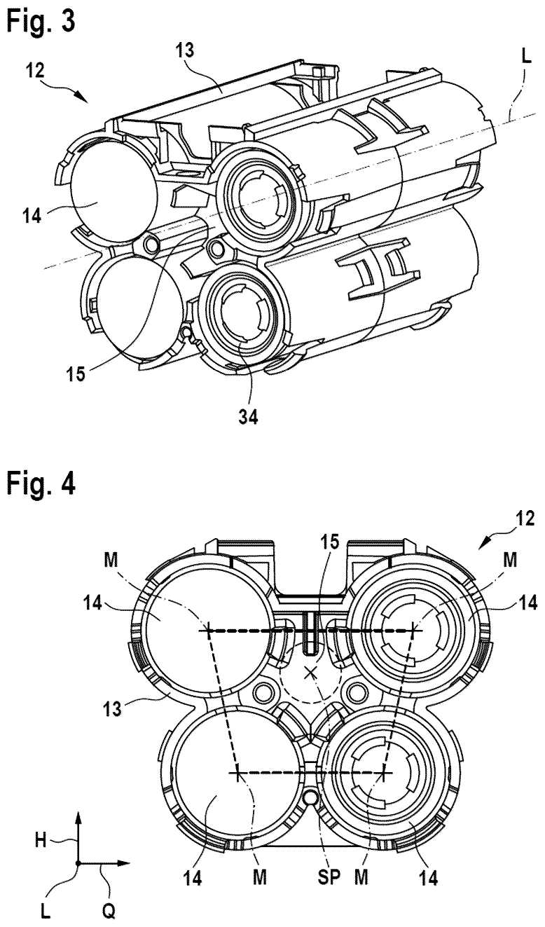

FIGS. 3 and 4 show schematic views of a battery cell pack 12, with battery cell pack 12 shown in FIG. 3 in an isometric view, and in FIG. 4 in a top plan view directed towards a front face, with the direction of view directed along the longitudinal axis L. Further, a transverse axis Q as well as a vertical axis H are also shown in FIG. 4, wherein the transverse axis Q and the vertical axis H are oriented orthogonally to each other and respectively orthogonally to the longitudinal axis L.

It will be apparent from FIGS. 3 and 4 that the battery cell pack 12 comprises at least one cell holder 13 as well as a plurality of battery cells 14. In the present case, the battery cell pack 12 comprises two cell holders 13, which are arranged adjacent to one another and in particular are identical or substantially identical.

The battery cells 14 are arranged on the cell holder 13 such that a cavity 15 is formed between the battery cells 14, wherein the cavity 15 is/is limited in scope, at least in sections, by the cell holder 13 and/or the battery cells 14.

It will further be seen from FIG. 4 that the battery cells 14 are arranged on the cell holder 13 such that center points M of the battery cells 14 form the corner points of an isosceles trapezoid in cross-section.

In the present case, the battery cells are cylindrical. The battery cells and the cell holder are configured or positioned with respect to each other such that a center of mass SP of the battery cell pack 12 lies in cross-section within the cavity 15.

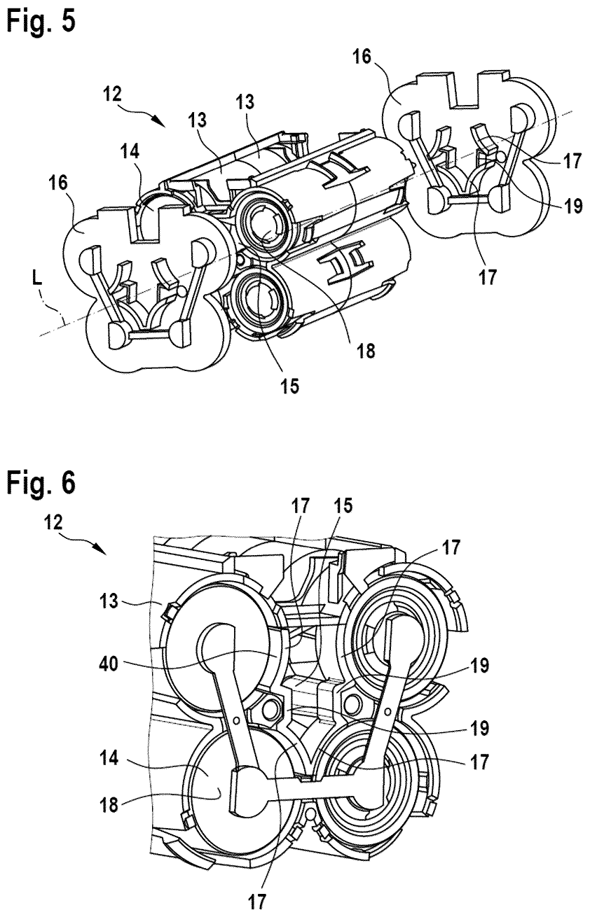

FIG. 5 illustrates the construction of the battery assembly 10 shown in FIG. 2 in the context of an exploded, sectional view. It will be appreciated that at least one end face along the longitudinal axis L on at least one battery cell pack 12 has a separating element 16 arranged, wherein the separating element 16 delimits the cavity 15 with respect to an extension along the longitudinal axis L. In particular, it can be provided that at least one battery cell pack 12 is arranged on end faces along the longitudinal axis of the separating elements 16 on both sides, as shown in FIG. 5. The two separating elements 16 shown in FIG. 5 are identical.

From FIG. 5 it can be seen that the separating elements 16 each comprise at least one protective rib 17 for, at least partially, shielding the cavity 15 from a hot gas escaping an end face 18 of a battery cell 14. Further, the separating elements 16 each comprise at least one centering rib 19 for centering the separating element 16 on the cell holder 13. The centering ribs 19 and the protective ribs 17 form a continuous rib contour. The described rib contour is identically formed for the separating elements 16 shown in FIG. 5 on both opposite sides of the separating elements 16, respectively.

The operation of the protection or centering ribs are illustrated in FIG. 6, wherein in FIG. 6 the representation of the separating element 16 was substantially limited to the corresponding rib elements 17, 19 and their cooperation with the cell holder 13. It will be apparent from FIG. 6 that the protective ribs 17 circumscribe the cavity 15 opposite the battery cell 14, at least in sections, and form a collar 40 projecting from the front face 18 of the battery cells 14 on the battery cell 14. It can also be seen that the centering ribs 19 are arranged, at least in sections, in contact with the cell holder 13.

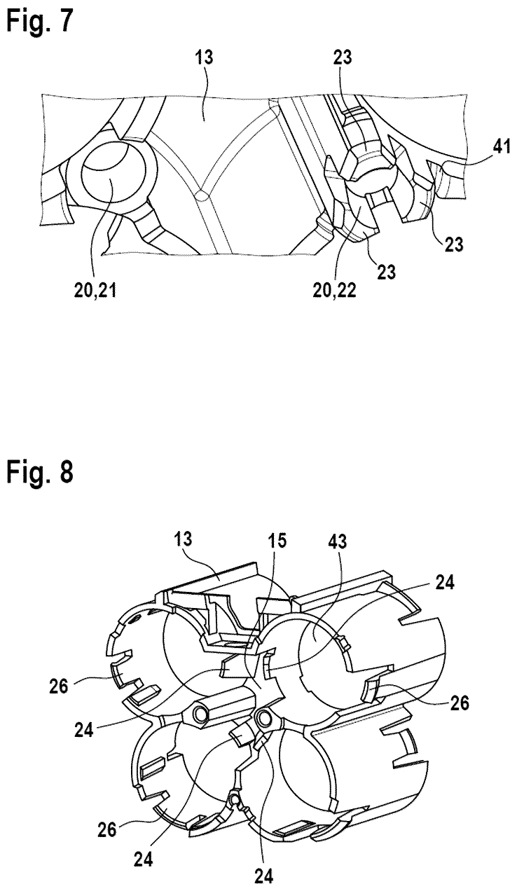

FIG. 7 further shows a schematic view of a cell holder 13, with the direction of view directed towards one side of the cell holder 13 facing the adjacent cell holder 13 in FIG. 3. It will be appreciated that the cell holder comprises centering mechanism 20 for centering on the adjacent cell holder 13. The centering mechanism 20 comprises at least one centering recess 21 for receiving, in particular a positive locking manner, a centering extension 22 and at least one centering extension 22 for insertion into a centering recess 21.

It will further be apparent from FIG. 7 that the centering extension 22 is formed by three spring segments 23 in the present case. At the ends of the spring segments 23 facing the cell holder 13, the material thickness of the cell holder 13 is locally reduced by grooves 41 to reduce the stiffness of the spring segments 23.

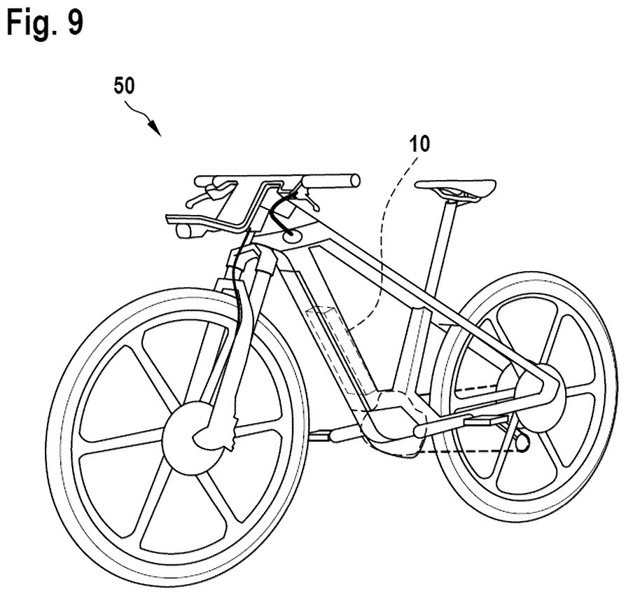

FIG. 8 further shows a schematic view of a cell holder 13. It will be appreciated that the cell holder 13 comprises at least one primary spring element 24 for securing a battery cell 14 to the cell holder 13, wherein the primary spring element 24 can be preloaded against the battery cell 14 by an arrangement of the battery cell 14 on the cell holder 13.

It can further be seen from FIG. 8 that the cell holder 13 comprises at least one secondary spring element 26 for securing the cell holder 13 in the housing 25 (cf. FIG. 1), wherein the secondary spring element 26 can be preloaded against the housing by an arrangement of the battery cell pack 12 in the housing 25.

In the present case, a plurality of primary and secondary spring elements 24, 26 are each comprised by the cell holder 13, wherein the spring elements are formed as leaf springs. Cylindrical receiving portions 43 are configured on the cell holder 13 to receive the battery cells 14, wherein the primary and secondary spring elements 24, 26 each form a wall of a receiving portion 43, at least in sections.

Further, it will be apparent from FIG. 8 that the primary spring elements 24 delimit the cavity 15, at least in sections, with respect to its circumference.

FIG. 9 also shows a schematic view of a pedal-powered vehicle 50 including at least one battery assembly 10.

The above explanation of the embodiments describes the present disclosure solely within the scope of examples. Of course, individual features of the embodiments can be freely combined with one another, if technically feasible, without leaving the scope of the present disclosure.

What is claimed is:

1. A battery assembly for a pedal driven vehicle, comprising at least one battery module, the battery module comprising a plurality of battery cell packs, wherein:
the battery cell packs are arranged in a row along a longitudinal axis,
at least one battery cell pack comprises at least one cell holder and a plurality of battery cells,
the battery cells are arranged on the cell holder in such a way that a cavity is formed between the battery cells, and
the cavity is delimited, at least in sections, by the cell holder and/or the battery cells with respect to its circumference.

2. The battery assembly according to claim 1, wherein the battery cells are arranged on the cell holder in such a way that area centers of the battery cells form a trapezoid in cross-section.

3. The battery assembly according to claim 1, wherein at least one battery cell is cylindrical and the cavity has a maximum width of at least 50% of the diameter of the battery cell and/or the cavity has a maximum depth of at least 85% of the diameter of the battery cell and/or the cavity has a maximum height that is less than the diameter of the battery cell.

4. The battery assembly according to claim 1, wherein a center of gravity of the at least one battery cell pack lies in cross-section within the cavity.

5. The battery assembly according claim 1, further comprising a separating element that is arranged at at least one end face of the at least one battery cell pack, wherein the separating element delimits the cavity with respect to an extension along the longitudinal axis.

6. The battery assembly according to claim 5, wherein:
the separating element comprises at least one protective rib configured to shield the cavity, at least partially, from a hot gas escaping an end face of a battery cell, and
the protective rib delimits the cavity from the battery cell, at least in sections, and is configured to form a collar on the battery cell that extends beyond the end face of the battery cell.

7. The battery assembly according to claim 5, wherein:
the separating element comprises at least one centering rib configured to center the separating element on the cell holder, and
the centering rib is arranged in contact with the cell holder at least in sections.

8. The battery assembly according to claim 6, wherein the at least one protective rib and at least one centering rib are configured as a continuous rib contour.

9. The battery assembly according to claim 1, wherein:
the cell holder comprises a centering mechanism configured to center on an adjacent cell holder, and
the centering mechanism comprises at least one centering recess configured to receive, in a form-fitting manner, a centering extension and at least one centering extension for insertion into a centering recess.

10. The battery assembly according to claim 9, wherein the at least one centering extension is formed by at least two spring segments.

11. The battery assembly according to claim 10, wherein at an end of at least one spring segment facing the cell holder, the material thickness of the cell holder is reduced, at least in sections.

12. The battery assembly according to claim 1, wherein
the cell holder comprises at least one spring element configured to secure a battery cell to the cell holder, and
the spring element is preloaded against the battery cell by arranging the battery cell on the cell holder.

13. The battery assembly according to claim 11, wherein the spring element delimits the cavity, at least in sections, with respect to its circumference.

14. The battery assembly according to claim 1, further comprising a housing configured to receive the at least one battery cell pack, wherein:
the cell holder comprises at least one spring element configured to secure the cell holder in the housing, and
the spring element is preloaded against the housing by arranging the battery cell pack in the housing.

15. A pedal driven vehicle comprising at least one battery assembly according to claim 1.

16. The battery assembly according to claim 2, wherein the trapezoid is an isosceles trapezoid.

17. The pedal driven vehicle according to claim 15, wherein the pedal driven vehicle is an electric bicycle.
